(19) United States
(12) Patent Application Publication
(10) Pub. No.: US 2007/0114759 A1
(43) Pub. Date: May 24, 2007

(54) Magnetic wedge device applied to the fifth wheel of trailer or semitrailer vehicles

(75) Inventors: Armando Biondi, SALA BOLOGNESE (IT); Paolo Martini, Avesa (IT)

Correspondence Address: GREENBERG TRAURIG LLP, 2450 COLORADO AVENUE, SUITE 400E, SANTA MONICA, CA, 90404, US

(73) Assignee: H.T.S. HYDRO TECH SYSTEMS SRL

(21) Appl. No.: 10/596,559

(22) PCT Filed: Dec. 17, 2004
(86) PCT No.: PCT/IT04/00707

§ 371 Date: Jun. 16, 2006

(30) Foreign Application Priority Data
Dec. 19, 2003 (IT) VR2003A000141

(51) Int. Cl. B62D 53/06; B60D 1/36

(52) U.S. Cl. 280/477; 280/434

(57) ABSTRACT

A magnetic wedge device for application on the fifth wheel of the tractor of articulated vehicles, by means of incorporated permanent magnets, to provide the angular position of the fifth wheel respect to the axis of a semitrailer to one or more functional systems dependent on this angular position and in particular to the piloting of semitrailer axle steering systems, consists of a wedge-shaped body (10) with a flat upper surface (12) equipped with permanent magnets (13) that maintain the body in contact with the flat surface of the semitrailer, close to the coupling pin (14) of the fifth wheel (11), and two flat side surfaces (15) equipped with permanent magnets (16) that maintain the body in contact with the two inner surfaces (17) of th “V” shaped opening in the fifth wheel in a fully wedged condition. The device presents a reference or coupling point (P) on which the end of a mechanical, hydraulic, pneumatic or electronic device (D) is applied, providing mechanical, hydraulic, pneumatic or electronic piloting corresponding to the position of the coupling point P on the wedge which is in turn proportional to the angular position of the fifth wheel with respect to the axis of the semitrailer. FIG. 1

### TECHNICAL FIELD

This invention concerns a device that is wedged into the particular “V” shape of the fifth wheel of the tractors of semitrailer vehicles.

This “V” shape of the fifth wheel is designed to allow the passage of the coupling pin of the semitrailer and the device according to the invention which is wedged into it is equipped with a mechanical and magnetic structure that attaches itself in a correct and interchangeable position on all the fifth wheels of tractors for semitrailer vehicles on the market.

The device according to the invention can be applied in all cases in which it is necessary to be able to-pilot a functional system dependent on the relative angular position between the tractor and the semitrailer, including hydraulic type applications such as, for example, steering systems for the wheels of one or more steering or self-steering axles of articulated vehicles consisting of a tractor unit and a semitrailer.

The device substantially consists of a wedge-shaped body with a flat upper surface equipped with permanent magnets that maintain the body in contact with the flat surface of the semitrailer around the fifth wheel coupling pin, and two flat side surfaces equipped with permanent magnets that maintain the body in contact with the two inner surfaces of the “V” shaped opening in the fifth wheel in a fully wedged condition.

This invention can be applied in the production sector of mechanical coupling means for the fifth wheels of the tractors and for the articulated vehicles on the market. More in general, the invention can be applied in the mechanical, agricultural and transport industry sectors.

### BACKGROUND ART

It is known that on articulated vehicles consisting of a tractor unit and a semitrailer, the detection and transmission, by means of the fifth wheel and its coupling pin, of the angular position of the tractor with respect to the semitrailer is considered to be difficult.

To date, a solution is known whereby a potentiometric transducer or encoder type of electronic device, incorporated in the semitrailer fifth wheel coupling pin, interacts with a reference element positioned on the tractor fifth wheel.

This solution involves the positioning of delicate electronic components in an area which is notoriously very dirty, being covered with a mixture of mud, water and grease, and the consequent weakening of the coupling pin of the semitrailer, pulled by the fifth wheel, which is considered as the safety organ of the vehicle. This is due to the presence of a through hole along the axis of the pin.

A mechanical solution for power transmission is also known in which a sturdy wedge is inserted in the “V” opening of the fifth wheel and is welded at the top to a rotating counter fifth wheel.

The counter fifth wheel, which is fixed to the semitrailer and rests against the fifth wheel as well as rotating on its own axis, is also pivoted on the axis of the fifth wheel coupling pin.

When the wedge is pulled by the fifth wheel, it makes the counter fifth wheel turn on its own axis and this in turn drives one or, more tie rods fixed at the end of the counter fifth wheel and connected to one or more axles of the semitrailer for mechanical steering.

This solution requires a very sturdy mechanical construction which is therefore heavy and cumbersome, considerably reducing the working load and the actual loading volume of the articulated vehicle.

### DESCRIPTION OF THE INVENTION

This invention proposes to overcome the problems and disadvantages of the background art and to provide a wedge device that can be connected to the fifth wheel of any articulated vehicle by particular means of adhesion consisting of incorporated permanent magnets, to give the angular position of the fifth wheel with respect to the axis of the semitrailer, to one or more functional systems dependent on this angular position and in particular to the piloting of axle steering systems on the semitrailer.

The invention also proposes to provide a magnetic wedge device for the fifth wheel of articulated vehicles that is easy to produce in order to be economically advantageous.

This is achieved by means of a magnetic wedge device designed to be coupled to the fifth wheel of tractors for semitrailers with the features described in the main claim.

The dependent claims describe advantageous embodiments of the invention.

The main advantages of this solution, in addition to those deriving from the construction simplicity rather than the traditional complexity of similar known systems, concern above all the greater security of the engagement and disengagement phases of the coupling organs between the tractor and the semitrailer.

The solution in question also offers the considerable advantage whereby the detachment of the magnetic wedge from the fifth wheel takes place automatically thanks to the particular construction of the wedge when the tractor, uncoupled from the semitrailer, begins to move.

After a few millimetres, the magnetic wedge strikes the fifth wheel pin, detaches itself from the fifth wheel and remains attached to the support base of the semitrailer close to the fifth wheel coupling pin due to the presence of the upper permanent magnets.

The attachment of the magnetic wedge to the fifth wheel takes place automatically a few millimetres before the fifth wheel of the tractor engages with the pin of the semitrailer thanks to the fact that following the previous detachment the wedge is close to the fifth wheel coupling pin.

The device consists of a wedge-shaped body with a flat upper surface equipped with permanent magnets, that maintain the body in contact with the flat surface of the semitrailer around the fifth wheel coupling pin, and two flat side surfaces equipped with permanent magnets, that maintain the body in contact with the two inner surfaces of the “V” shaped opening in the fifth wheel in a fully wedged condition.

The wedge presents a reference or coupling point (e.g. a hole) in which the end of a mechanical, hydraulic, pneumatic or electronic device is inserted and which provides mechanical, hydraulic, pneumatic or electronic piloting corresponding to the angular position of the coupling point with respect to the axis of the fifth wheel coupling pin, which is in turn proportional to the, angular position of the fifth wheel with respect to the axis of the semitrailer.

During the rotation of the fifth wheel with respect to the axis of its coupling pin the magnetic wedge follows this rotation remaining wedged in the “V” of the fifth wheel by the side permanent magnets and remaining attached by the permanent magnets on the upper surface of the wedge to the support base of the semitrailer on the fifth wheel with a very limited degree of friction due to the presence of a considerable amount of grease.

The detachment of the wedge from the upper contact with the semitrailer is also prevented by the fact that the flat side surfaces are inclined along the vertical axis by the same draft angle as the “V” opening in the fifth wheel which is narrower on the lower side.

During the rotation the reference or coupling point on the wedge also rotates around the fifth wheel pin, with a consequent proportional variation of the piloting value.

Thanks to the mechanical and magnetic structure of the wedge, it attaches itself in a correct and interchangeable position on all the fifth wheels of tractors for articulated vehicles on the market. This allows it to be inserted in all applications which require the piloting of a functional system dependent on the relative angular position between the tractor and the semitrailer, including hydraulic type applications such as, for example, the steering of wheels of one or more steering or self-steering axles of articulated vehicles consisting of a tractor pulling a semitrailer.

The rotation around the fifth wheel axis of the magnetic wedge coupling point, pulling the end of the pivoted device on the other end, causes the rotation of a piloting lever by means of a flexible cable or of an angular transducer or of an encoder etc. by an angle proportional to the angle of the fifth wheel on its pin.

### DESCRIPTION OF THE DRAWINGS

Other features and advantages of the invention will become evident on reading the following description of one embodiment of the invention, given as a non-binding example, with the help of the attached drawings, in which:

FIG. 1 represents a schematic plan view of the fifth wheel and of the relative wedge coupling means equipped with magnetic elements according to the invention;

FIG. 2 is a schematic view showing one of the two side sectors of the wedge according to the cross-section A-A of FIG. 1;

FIG. 3 is a schematic cross-section view along the line B-B of the wedge sector equipped with magnetic elements;

FIG. 4 represents a schematic view from above of the coupling zone of the articulated vehicle in a straight-line position, in which the magnetic wedge is connected to a linear movement device pivoted to the opposite end to achieve the rotation of a piloting system by means of a flexible cable or an angular transducer, etc.;

FIG. 5 represents a view from above of the magnetic wedge device in the previous figure in a condition in which the tractor is at an angle to the axis of the semitrailer;

FIG. 6 is a detailed cross-section view showing one of the two side sectors of the wedge along the line A-A of FIG. 1;

FIG. 7 is a detailed cross-section view along the line B-B of the wedge sector equipped with magnetic elements;

FIG. 8 is a schematic plan view of the fifth wheel and of the respective magnetic wedge according to a possible variation;

FIG. 9 represents a partial side cross-section view of the magnetic wedge and the respective pin along the line A-A of FIG. 8;

FIG. 10 represents a partial side cross-section view of the magnetic wedge and the respective pin along the line A-A of FIG. 8 and in a possible variation with sensors for detecting the angular movements of the semitrailer;

FIG. 11 represents the schematic view of one of the elastic pushing devices positioned on at least one of the sides of the magnetic wedge;

figures 12 and 13 represent schematic views of the fifth wheel and of the respective magnetic wedge in the two angular positions.

### DESCRIPTION OF ONE EMBODIMENT OF THE INVENTION

The invention therefore proposes to provide a wedge device 10 which connects to the fifth wheel 11 of any articulated vehicle though the use of adhesion elements that carry out the coupling phases between the fifth wheel and the wedge.

These adhesion elements are represented by permanent magnets which are incorporated in the wedge so that it can provide the angular position of the fifth wheel, with respect to the axis of the semitrailer, to one or more functional systems dependent on this angular position.

In particular, the wedge equipped with these permanent magnets establishes the angular position for the piloting of the axle steering systems on the semitrailer.

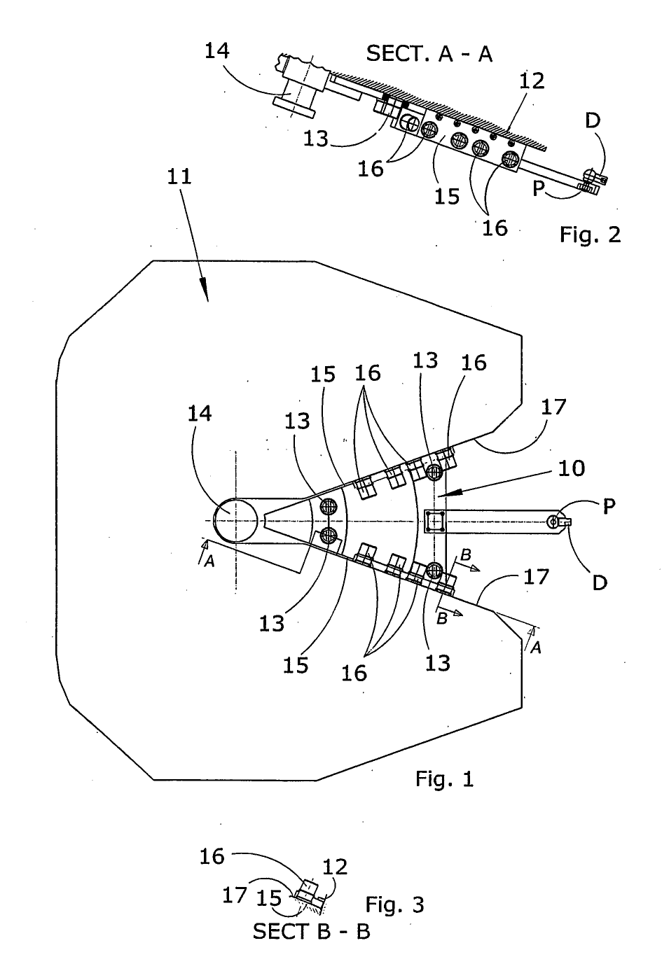

The device thus consists of a wedge-shaped body 10 with a flat upper surface 12 equipped with permanent magnets 13 (FIG. 1) that maintain the body in contact with the flat surface of the semitrailer around the coupling pin 14 of the fifth wheel 11.

In the same way, the two flat side surfaces 15 of the wedge are equipped with further permanent magnets 16 which keep the body of the wedge 10 in contact with the two inner surfaces 17 of the “V” shaped opening of the fifth wheel 11 in a fully wedged condition.

The wedge 11 presents a coupling point P (e.g. a hole) in which the end of a mechanical, hydraulic, pneumatic or electronic device, indicated with D, is inserted, providing mechanical, hydraulic, pneumatic or electronic piloting corresponding to the angular position P of the coupling point P on the wedge 10, which is in turn proportional to the angular position a of the fifth wheel with respect to the axis of the semitrailer.

During the rotation of the fifth wheel 11 with respect to the axis of its coupling pin 14, the magnetic wedge follows this rotation while remaining wedged in the “V” shaped opening of the fifth wheel by means of the side permanent magnets and held at the top by the permanent magnets mounted on the upper surface of the-wedge in contact with the support base of the semitrailer on the fifth wheel with very limited friction due to the presence of a considerable amount of grease.

The detachment of the, wedge from its upper contact on the semitrailer is also hindered by the fact that the flat side surfaces 15 are inclined along the vertical axis of the same draft angle φ of the “V” shaped opening in the fifth wheel 11 which has a narrower “V” on the lower side.

During the rotation, the coupling point P on the wedge also naturally rotates around the fifth wheel pin 14 with a consequent proportional variation of the piloting value.

The detachment of the magnetic wedge 10 from the fifth wheel 11 takes place automatically thanks to the particular construction of the magnetic wedge 10 when the tractor is uncoupled from the semitrailer and begins to move.

After a few millimetres, the wedge 10 strikes the fifth wheel pin 14, detaches itself from the fifth wheel 11 and remains attached to the support base of the semitrailer close to the fifth wheel coupling pin due to the presence of the upper permanent magnets 13.

Attachment of the magnetic wedge 10 to the fifth wheel 11 takes place automatically a few millimetres before the fifth wheel of the tractor engages the pin of the semitrailer thanks to the fact that as a result of the previous uncoupling the wedge is close to the fifth wheel coupling pin.

Thanks to its mechanical and magnetic structure, the magnetic wedge 10 attaches itself in a correct and interchangeable position on all the fifth wheels of tractor units for articulated vehicles currently on the market.

This allows it to be applied in all cases in which it is necessary to pilot a functional system dependent on the relative angular position between the tractor and the semitrailer, including hydraulic type applications such as, for example, the steering of wheels of one ore more steering or self-steering axles of articulated vehicles consisting of a pulling tractor and a semitrailer.

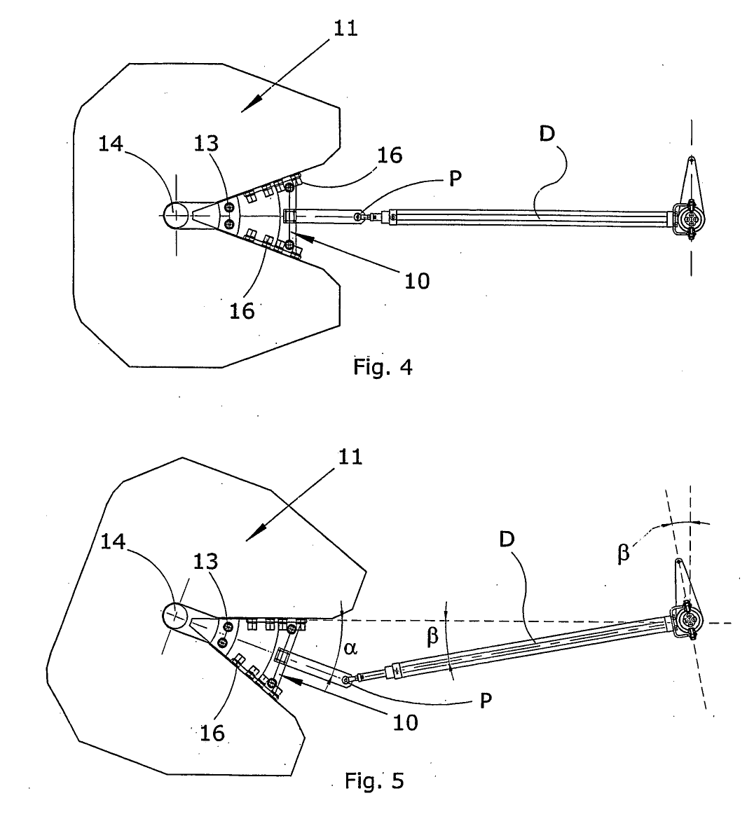

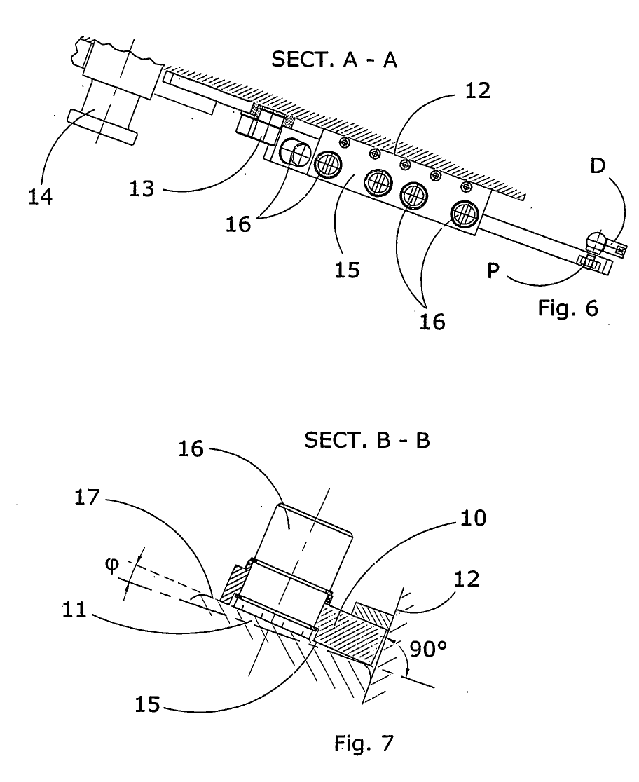

An example of these applications is shown in FIGS. 4 and 5, representing the straight-line driving condition of the articulated vehicle and the condition in which the tractor is at an angle with respect to the axis of the semitrailer.

As can be seen, the rotation a on the fifth wheel axis of the coupling point P on the magnetic wedge, pulling the end of the device D pivoted on the other end, causes the rotation of a piloting lever by means of a flexible cable, an angular transducer or an encoder etc. by an angle β proportional to the angle of the fifth wheel on its coupling pin.

According to the alternative embodiment shown in FIG. 9, a solution is indicated that can be used on articulated vehicles in which the semitrailer is equipped with a pin 14 presenting a flange 14′ fixing it to the semitrailer, and with an annular groove 19, which is in a position protected from any interference.

This groove houses an annular flange 18 positioned at the end of the magnetic wedge 10.

More specifically, the central part of this flange 18 presents a circular opening, with an annular border, through which the pin 14 passes and which is positioned in the groove 19 cut in the area around the pin 14.

As can be seen in FIG. 10, the annular border of the flange 18 can be equipped with teeth 20 that represents a “phonic wheel” for measuring the angular movement between the tractor and the semitrailer detected by probes 21, consisting of one or more proximity switches or the like inserted in the fixed base of the pin 14.

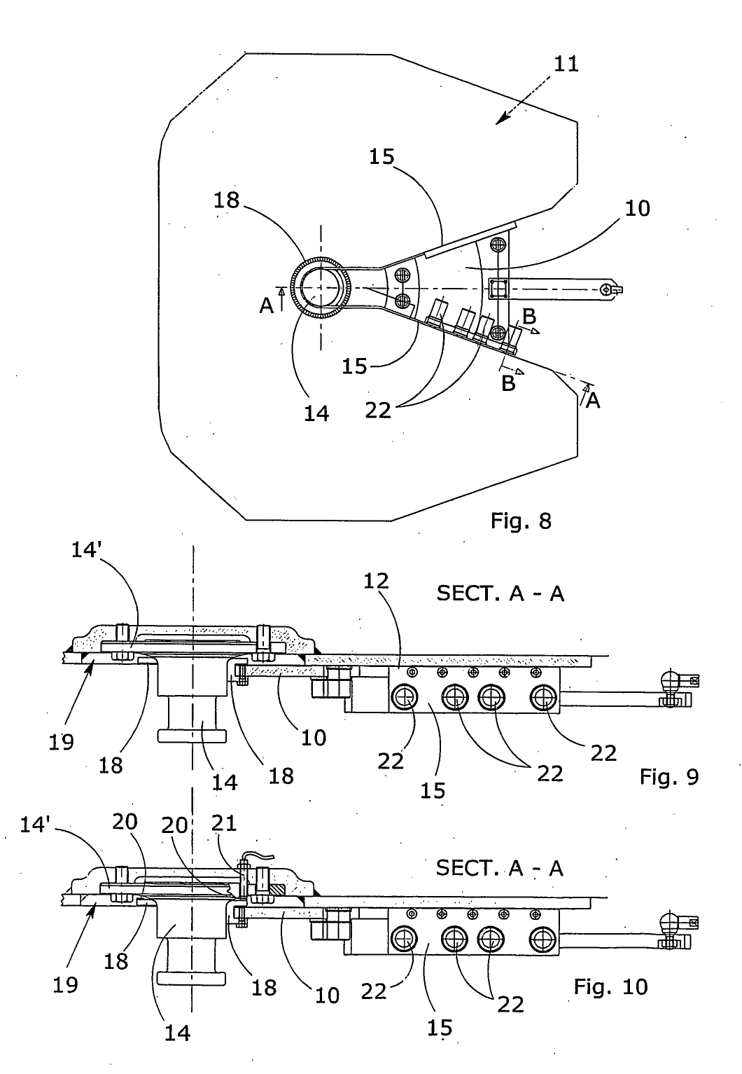

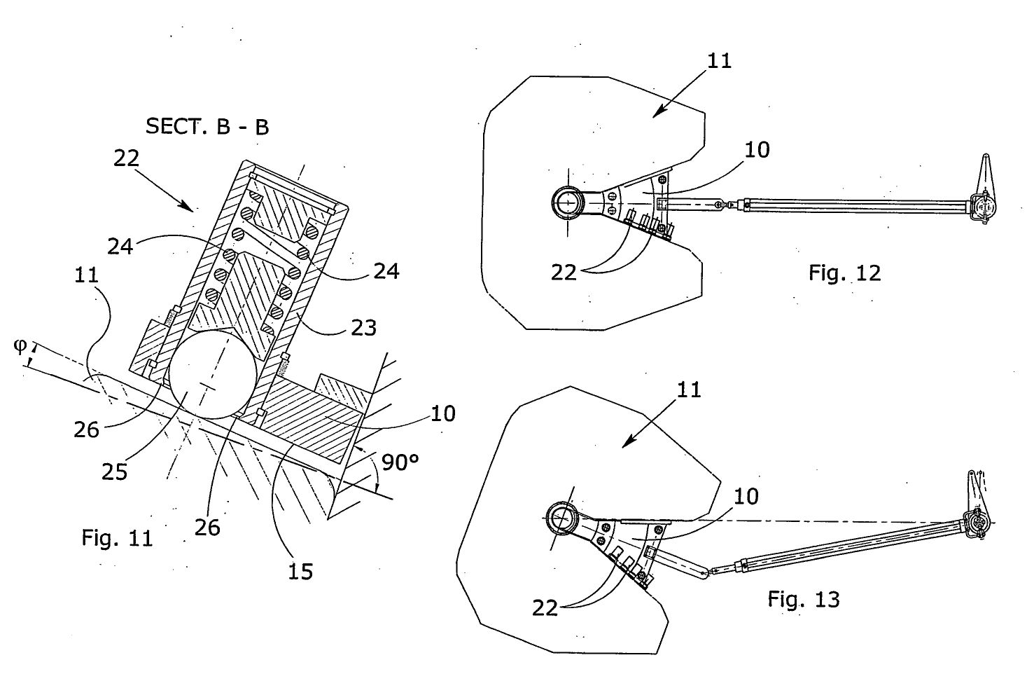

According to another embodiment, the magnetic wedge device 10 can comprise, close to at least one of its two side surfaces 15, elastic pushing elements 22 visible in FIGS. 8 to 13 and in the detail of FIG. 11.

The elastic pushing elements 22, present on only one side of the wedge, act by holding the other side of the magnetic wedge 10 against the corresponding “V” opening in the fifth wheel 11.

According to a particularly advantageous embodiment of the invention, each elastic pushing element 22 consists of a hollow cylindrical body 23 housing a spring 24 which acts on a ball 25 pushing it outwards but which is held in its seat by a restricting border 26.

The balls 25 therefore normally remain pushed out from the walls of the magnetic wedge 10, pressing against the corresponding side of the “V” shaped opening in the fifth wheel 11. The pressing action of the balls causes a reaction that pushes the magnetic wedge 10 against the other side, i.e. the corresponding opposite side of the “V” shaped opening in the fifth wheel.

The invention is described above with reference to a preferred embodiment. It is nevertheless clear that it is susceptible to numerous variations that are within its scope, in the framework of technical equivalents.

1. A magnetic wedge device for application on the fifth wheel of the tractor of articulated vehicles, said fifth wheel having a “V” shape opening suitable for receiving the coupling pin of a trailer or semitrailer, said wedge comprising a wedge-shaped body with a flat upper surface equipped with permanent magnets that maintain said body in contact with the flat surface of a trailer or semitrailer, close to said coupling pin, and two flat side surfaces equipped with permanent magnets that maintain the body in contact with the two inner surfaces of the “V” shaped opening in the fifth wheel in a fully wedged condition, wherein said magnetic wedge device has a reference or coupling point on which the end of a mechanical, hydraulic, pneumatic or electronic device is applied, providing mechanical, hydraulic, pneumatic or electronic piloting corresponding to the position of the coupling point on the wedge which is in turn proportional to the angular position of the fifth wheel with respect to the axis of the trailer or semitrailer.

2. The magnetic wedge device of claim 1 in which the flat side surfaces are also inclined along the vertical axis by the same draft angle φ as the “V” shaped opening in the fifth wheel which has a narrower “V” on the lower side, further favouring the upper contact of the wedge with the semitrailer.

3. The magnetic wedge device of claim 2, wherein its detachment from the fifth wheel takes place automatically, thanks to the particular construction of the magnetic wedge, when the tractor is uncoupled from the semitrailer and begins to move, and in this phase, after a few millimetres, the wedge strikes the fifth wheel coupling pin, detaches itself from the fifth wheel and remains in contact with the support base of the semitrailer close to the fifth wheel coupling pin due to the presence of the upper permanent magnets.

4. The magnetic wedge device of claim 3, wherein the attachment of the magnetic wedge to the fifth wheel takes place automatically a few millimetres before fifth wheel of the tractor engages with the pin of the semitrailer thanks to the fact as a result of the previous uncoupling the wedge is close to the fifth wheel coupling pin.

5. The magnetic wedge device of claim 1, wherein during the rotation of the fifth wheel with respect to the axis of the fifth wheel coupling pin the magnetic wedge follows the rotation while remaining wedged in the “V” shaped opening of the fifth wheel by means of the side permanent magnets and held up by the permanent magnets mounted on the upper surface of the wedge against the support base of the semitrailer on the fifth wheel with very limited friction due to the presence of a considerable amount of grease.

6. The magnetic wedge device of claim 1 in wherein during the rotation α of the fifth wheel with respect to the axis of the fifth wheel coupling pin the coupling or reference point on the wedge also turns around the pin with a consequent proportional variation of the piloting value.

7. The magnetic wedge device of claim 6, wherein this coupling or reference point to which the end of a mechanical, hydraulic, pneumatic or electronic device is applied, consists of a hole, a pin or any other type of pivot suitable for any type of coupling.

8. The magnetic wedge device of claim 1, in which one end presents an annular flange with a circular opening in its central part, bordered by an annular rim, through which the pin passes, the flange being positioned in a groove around the base of the pin.

9. The magnetic wedge device of claim 8, wherein the flange is equipped with teeth of the “phonic wheel” type suitable for measuring the angular movement between the tractor and the semitrailer detected by means of probes inserted in the fixed base of the pin.

10. The magnetic wedge device of claim 1 further comprising, close to at least one of its side surfaces, elastic pushing elements that act by holding the other side of the magnetic wedge against the corresponding side of the “V” shaped opening in the fifth wheel.

11. The magnetic wedge device of claim 10, wherein each of the elastic pushing elements consists of a hollow cylindrical body housing a spring which acts on a ball pushing it outwards but which is held in its seat by a restricting border.

12. The magnetic wedge device of claim 1, wherein its mechanical and magnetic structure is the universal type and allows it to attach itself in a correct and interchangeable position on all the fifth wheels of tractors for articulated vehicles on the market.
